(19) United States
(12) Patent Application Publication
(10) Pub. No.: US 2026/0267613 A1
(43) Pub. Date: Sep. 10, 2026

(54) METHOD AND SYSTEM FOR DETERMINING A PRIORITY OF IMPLEMENTATION FOR INPUT REQUIREMENTS

(71) Applicant: L&T TECHNOLOGY SERVICES LIMITED, Chennai (IN)

(72) Inventors: NIVEDITHA SURESHBABU, Bengaluru (IN); AVANTHIKA RAGUNATHAN, Coimbatore (IN)

(21) Appl. No.: 19/223,181

(22) Filed: May 30, 2025

(30) Foreign Application Priority Data
Mar. 4, 2025 (IN) 202541019136

(51) Int. Cl. G06F 8/10

(52) U.S. Cl. CPC G06F 8/10

(57) ABSTRACT

A method for determining a priority of implementation for input requirements is disclosed. The method includes adding a set of input requirements to a requirement repository. The requirement repository may include a set of existing requirement clusters. Each of the set of existing requirement clusters may include a set of existing requirements. For each input requirement of the set of input requirements, the method further includes determining, via a GenAI model, a weighted average score through a comparison of the input requirement with each of the set of existing requirements in each of the set of existing requirement clusters, based on a set of predefined criteria. The method further includes determining a priority of implementation for the set of input requirements based on the weighted average score.

### TECHNICAL FIELD

This disclosure relates requirement analysis, and more particularly to method and system for determining a priority of implementation for input requirements.

### BACKGROUND

In Software Development Life Cycle (SDLC), requirement analysis phase is crucial phase for creating effective test cases for software testing. In the requirement analysis phase for a software product, the requirements are typically structured hierarchically (i.e., starting from high-level needs of business and goals). Further, these high-level requirements are subcategorized into multiple low-level requirements, detailing the specific components, and functionalities needed to meet the overarching objectives. Further, the requirements may evolve as new features and functionalities are added to the software product and the existing functionalities are updated regularly to adapt to new innovations, user needs, market trends, and the like.

In the present state of art, modification in the requirements may be done manually. However, manual modification has several challenges. A significant challenge may be a difficulty in tracing new requirements and sub-requirements to existing requirements. Without a systematic approach to mapping, the opportunity to reuse existing design assets and test cases is often missed. This may lead to a lack of reusability of existing design assets, wastage of time, inconsistencies in testing, and misalignment with project goals. Additionally, the new requirements often bring novel aspects that, if not clearly differentiated from existing ones, may result in unclear test objectives. Without thorough mapping between old and new requirements, critical test scenarios may be overlooked, while irrelevant ones may be included, leading to inefficiencies. Consequently, a priority of implementation of the new requirements may not be clearly defined, eventually resulting in poor test case coverage and an inefficient testing phase in the SDLC.

The present invention is directed to overcome one or more limitations stated above or any other limitations associated with the known arts.

### SUMMARY

In some embodiment, a method for determining a priority of implementation for input requirements is disclosed. In one example, the method may include adding a set of input requirements to a requirement repository. It should be noted that the requirement repository may include a set of existing requirement clusters. It should be noted that each of the set of existing requirement clusters may include a set of existing requirements. For each input requirement of the set of input requirements, the method may further include determining, via a generative Artificial Intelligence (GenAI) model, a weighted average score through a comparison of the input requirement with each of the set of existing requirements in each of the set of existing requirement clusters, based on a set of predefined criteria. It should be noted that the set of predefined criteria may include relevancy, redundancy, and uniqueness. The method may further include determining a priority of implementation for the set of input requirements based on the weighted average score. It should be noted that the priority for implementation corresponds to an ordered list of the set of input requirements based on the weighted average score.

In another embodiment, a system for determining a priority of implementation for input requirements is disclosed. In one example, the system may include a processor and a computer-readable medium communicatively coupled to the processor. The computer-readable medium may store processor-executable instructions, which, on execution, may cause the processor to add a set of input requirements to a requirement repository. It should be noted that the requirement repository may include a set of existing requirement clusters. It should be noted that each of the set of existing requirement clusters may include a set of existing requirements. For each input requirement of the set of input requirements, the processor-executable instructions, on execution, may further cause the processor to determine, a GenAI model, a weighted average score through a comparison of the input requirement with each of the set of existing requirements in each of the set of existing requirement clusters, based on a set of predefined criteria. It should be noted that the set of predefined criteria may include relevancy, redundancy, and uniqueness. The processor-executable instructions, on execution, may further cause the processor to determine a priority of implementation for the set of input requirements based on the weighted average score. It should be noted that the priority for implementation corresponds to an ordered list of the set of input requirements based on the weighted average score.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for determining a priority of implementation for input requirements, in accordance with some embodiments of the present disclosure.

FIG. 2 illustrates a functional block diagram of a system for determining the priority of implementation for the input requirements, in accordance with some embodiments of the present disclosure.

FIGS. 3A, 3B, and 3C are flow diagrams of an exemplary process for determining the priority of implementation for the input requirements, in accordance with some embodiments of the present disclosure.

FIGS. 4A and 4B are flow diagrams of a detailed exemplary process for computing a relevancy score for the input requirements, in accordance with some embodiments of the present disclosure.

FIG. 5 is a flow diagram of a detailed exemplary process for calculating a reusability score for the input requirements, in accordance with some embodiments of the present disclosure.

FIGS. 6A and 6B are flow diagrams of a detailed exemplary process for calculating a uniqueness score for the input requirements, in accordance with some embodiments of the present disclosure.

FIG. 7 is a flow diagram of a detailed exemplary process for assigning a hierarchy rank to the input requirements, in accordance with some embodiments of the present disclosure.

FIG. 8 illustrates an exemplary requirement analysis report, in accordance with some embodiments of the present disclosure.

FIG. 9 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

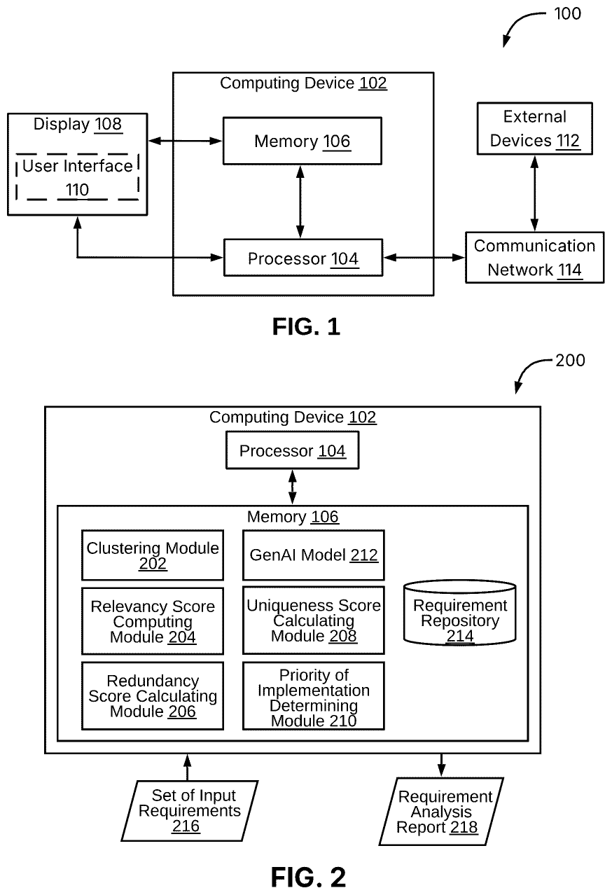

Referring now to FIG. 1, an exemplary system 100 for determining a priority of implementation for input requirements is illustrated, in accordance with some embodiments of the present disclosure. The system 100 may include a computing device 102. The computing device 102 may be, for example, but may not be limited to, server, desktop, laptop, notebook, netbook, tablet, smartphone, mobile phone, or any other computing device, in accordance with some embodiments of the present disclosure. The computing device 102 may determine a priority of implementation for input requirements using a Generative Artificial Intelligence (GenAI) model (for example, a Large Language Model (LLM)). Further, the computing device 102 may generate a requirement analysis report based on the priority of implementation for the input requirements.

As will be described in greater detail in conjunction with FIG. 2-9, in order to determine a priority of implementation for input requirements, the computing device 102 may add a set of input requirements to a requirement repository. It should be noted that the requirement repository may include a set of existing requirement clusters. Each of the set of existing requirement clusters may include a set of existing requirements. For each input requirement of the set of input requirements, the computing device 102 may further determine, via a GenAI model, a weighted average score through a comparison of the input requirement with each of the set of existing requirements in each of the set of existing requirement clusters, based on a set of predefined criteria. It should be noted that the set of predefined criteria may include at least one of relevancy, redundancy, and uniqueness. The computing device 102 may further determine a priority of implementation for each of the set of input requirements based on the weighted average score. It should be noted that the priority for implementation corresponds to an ordered list of the set of input requirements based on the weighted average score.

In some embodiments, the computing device 102 may include one or more processors 104 and a memory 106. Further, the memory 106 may store instructions that, when executed by the one or more processors 104, may cause the one or more processors 104 to determine a priority of implementation for input requirements, in accordance with aspects of the present disclosure. The memory 106 may also store various data (for example, existing requirements, existing requirement clusters, GenAI model data, and the like) that may be captured, processed, and/or required by the system 100.

The system 100 may further include a display 108. The system 100 may interact with a user interface 110 accessible via the display 108. The system 100 may also include one or more external devices 112. In some embodiments, the computing device 102 may interact with the one or more external devices 112 over a communication network 114 for sending or receiving various data. The communication network 114 may include, for example, but may not be limited to, a wireless fidelity (Wi-Fi) network, a light fidelity (Li-Fi) network, a local area network (LAN), a wide area network (WAN), a metropolitan area network (MAN), a satellite network, the internet, a fiber optic network, a coaxial cable network, an infrared (IR) network, a radio frequency (RF) network, and a combination thereof. The one or more external devices 112 may include, but may not be limited to, a remote server, a laptop, a netbook, a notebook, a smartphone, a mobile phone, a tablet, or any other computing device.

Referring now to FIG. 2, a functional block diagram of a system 200 for determining the priority of implementation for the input requirements is illustrated, in accordance with some embodiments of the present disclosure. FIG. 2 is explained in conjunction with FIG. 1. The system 200 may be analogous to the system 100. The system 200 may implement the computing device 102. In an embodiment, the system 200 may be configured to determine the priority of implementation for the input requirements by determining a weighted average score for each of the input requirements based on the set of predefined criteria including relevancy, redundancy, and uniqueness. Relevancy may be based on alignment of an input requirement with the existing requirements. Higher relevancy may indicate better traceability and relevance. Redundancy of the input requirement may be determined based on an extent to which existing requirements can be reused in place of the input requirement. Lower redundancy (or higher reusability) may indicate greater efficiency in reuse potential of the existing requirements. Uniqueness is based on whether the input requirement has distinct functionalities from other input requirements. Higher uniqueness ensures that the input requirement adds value and avoids duplication. The memory 106 of the computing device 102 may include a clustering module 202, a relevancy score computing module 204, a redundancy score calculating module 206, a uniqueness score calculating module 208, a priority of implementation determining module 210, a GenAI model 212, and a requirement repository 214.

The requirement repository 214 may include a plurality of existing requirements. The plurality of existing requirements may be obtained from one of existing projects, existing documentations (such as a Requirement Specification Document (RSD), a Business Requirement Document (BRD), and the like), reports, and memory archives, and the like, within the requirement repository 214. In some embodiments, the plurality of existing requirements may be obtained from an external repository. Upon obtaining a requirement, the clustering module 202 may add that requirement to the requirement repository 214.

Further, the clustering module 202 may receive (or retrieve) the plurality of existing requirements from the requirement repository 214. Each of the plurality of existing requirements may be stored with a requirement ID and a description. By way of an example, the clustering module 202 may receive four existing requirements from the requirement repository 214. The requirement IDs of the four existing requirements may be ‘Existing_Req_1’, ‘Existing_Req_2’, ‘Existing_Req_3’, and ‘Existing_Req_4’. The description corresponding to the requirement ID ‘Existing_Req_1’ may be ‘The email must be validated against the database’. The description corresponding to the requirement ID ‘Existing_Req_2’ may be ‘The password must be encrypted and stored securely’. The description corresponding to the requirement ID ‘Existing_Req_3’ may be ‘Log must include the timestamp and IP address of login attempts’. The description corresponding to the requirement ID ‘Existing_Req_4’ may be ‘Failed login attempts must be flagged for review’.

Initially, the clustering module 202 may preprocess the plurality of existing requirements using a set of preprocessing techniques. The clustering module 202 may remove noise from a content (or description) of the plurality of existing requirements. The noise may be, for example, but may not be limited to, repetitive terms, abbreviation, and ambiguous terms. Additionally, the clustering module 202 may convert the plurality of existing requirements into a vector format. By way of an example, the vector format may be one of a Scalable Vector Graphics (SVG), an Encapsulated PostScript (EPS), and a Portable Document Format (PDF).

Further, upon preprocessing, the clustering module 202 may cluster each of the plurality of existing requirements into a set of existing requirement clusters based on predefined criteria using one of a clustering algorithm or a GenAI model 212. It should be noted that each of the set of existing requirement clusters may include a set of existing requirements. Additionally, the set of existing requirement clusters may be stored in the requirement repository 214. The predefined criteria may be, for example, but may not be limited to, a similarity measure or categorization. The similarity measure may be, for example, but may not be limited to, a Euclidean distance, a Manhattan distance, or a Minkowski distance. The clustering algorithm may be, for example, but may not be limited to, a K-means clustering, a hierarchical clustering, a Density Based Spatial Clustering of Application Noise (DBSCAN) clustering, an Expectation Maximization (EM) algorithm, or a spectral clustering. In an embodiment, the GenAI model 212 may be a Large Language Model (LLM).

In continuation with the above example, the clustering module 202 may cluster each four existing requirements into two clusters based on similarity measures. For example, cluster IDs of the two clusters may be ‘R1_Cluster1’, and ‘R2_Cluster2’. The description corresponding to the cluster ‘R1_Cluster1’ may be ‘The system must support login functionality using email and password’. The description corresponding to the cluster ‘R2_Cluster2’ may be ‘The system must log all user login attempts for audit purposes’. The cluster ‘R1_Cluster1’ may include the existing requirements ‘Existing_Req_1’ and ‘Existing_Req_2’. Similarly, the cluster ‘R1_Cluster2’ may include the existing requirements ‘Existing_Req_3’ and ‘Existing_Req_4’.

In an embodiment, the clustering module 202 may cluster the plurality of existing requirements into a thematic cluster. The thematic cluster may be, for example, but may not be limited to, a user authentication, and a notification management.

Further, a stakeholder may provide a set of input requirements 216 (i.e., new requirements) to the clustering module 202 through a UI (such as the UI 110). The stakeholder may be, for example, but may not be limited to, a project team member, customers, a software developer, and a programmer. The set of input requirements 216 may be received in a natural language from the stakeholder. Further, the clustering module 202 may add the set of input requirements 216 to the requirement repository 214. From hereon, the requirement repository 214 may include both the set of input requirements 216 and the set of existing requirements (in the form of the set of existing requirement clusters).

By way of an example, the clustering module 202 may add three input requirements into the requirement repository 214. The requirement ID corresponding to the three input requirements may be ‘New_Req_A’, ‘New_Req_B’, and ‘New_Req_C’. The description corresponding to the input requirement ‘New_Req_A’ may be ‘The system should support login functionality’. The description corresponding to the input requirement the ‘New_Req_B’ may be ‘The system should allow login attempts to be blocked after 5 consecutive failed attempts’. The description corresponding to the input requirement ‘New_Req_C’ may be ‘Unsuccessful login attempts should be marked for further review’.

Further, for each input requirement of the set of input requirements 216, the relevancy score computing module 204 may determine, via the GenAI model 212, a weighted average score through a comparison of the input requirement with each of the set of existing requirements in each of the set of existing requirement clusters, based on a set of predefined criteria. The set of predefined criteria may include at least one of relevancy, redundancy, or uniqueness. For comparing the input requirement based on a predefined criteria of relevancy, the relevancy score computing module 204 may compute, via the GenAI model 212, a relevancy score of the input requirement based on a relevancy comparison of the input requirement with each of the set of existing requirement clusters.

For each of the set of existing requirement clusters, the relevancy score computing module 204 may generate, via the GenAI model 212, a question based on each existing requirement of the set of existing requirements to obtain a set of questions. Further, for each of the set of input requirements 216, the relevancy score computing module 204 may generate, via the GenAI model 212, an answer based on the input requirement corresponding to each of the set of questions, to obtain a set of answers. Further, the relevancy score computing module 204 may compute, via the GenAI model 212, the relevancy score corresponding to the input requirement based on the comparison between each of the set of answers with the corresponding set of questions.

In other words, the relevancy score computing module 204 may compute the relevancy score for each of the set of input requirements 216 based on an alignment with the set of existing requirements. The relevancy score may be normalized to the range of (0-1). It should be noted that a higher relevancy score may indicate better traceability and relevance of the input requirement.

Further, for comparing the input requirement based on a predefined criterion of redundancy, the redundancy score calculating module 206 may calculate, via the GenAI model 212, a redundancy score of the input requirement based on a metadata overlap analysis between the input requirement and each of the set of existing requirement clusters.

To calculate the redundancy score, for each of the set of existing requirement clusters, the redundancy score calculating module 206 may compare, via the GenAI model 212, metadata of the input requirement with each existing requirement of the set of existing requirements. It should be noted that the metadata may include description content associated with the input requirement. Further upon comparison, the redundancy score calculating module 206 may calculate, via the GenAI model 212, the redundancy score of the input requirement based on the comparison. The redundancy score may be fall under a range of (0-1). A higher redundancy score may indicate a higher probability that the input requirement may be covered by one or more of the set of existing requirements.

Further, for comparing the input requirement based on a predefined criteria of uniqueness, the uniqueness score calculating module 208 may calculate, via the GenAI model 212, the uniqueness score of the input requirement based on an iterative comparison amongst the one or more new requirements. To calculate the uniqueness score of the input requirement, for each of the set of input requirements, the uniqueness score calculating module 208 may generate, via the GenAI model 212, a set of level classifications corresponding to the input requirement. By way of an example, the set of level classifications may include a high level classification, a medium level classification, and a low level classification.

Further, the uniqueness score calculating module 208 may randomly create, via the GenAI model 212, one or more batches from the set of input requirements. Each of the one or more batches may include a first predefined number of input requirements. In other words, if a number of the set of input requirements 216 is more than the first predefined number of input requirements, then, in such cases, the uniqueness score calculating module 208 may split the dataset into one or more batches for better evaluation. For example, the first predefined number of the input requirement may be ‘5’. If the number of the set of input requirements 216 is 17, 4 batches may be created. Out of the 4 batches, 3 batches may include 5 input requirements each, and a remaining fourth batch may include 2 input requirements.

Further, for each of the one or more iterations, the uniqueness score calculating module 208 may assign, via the GenAI model 212, for each of the one or more batches, a hierarchy rank to each of the first predefined number of input requirements in the batch based on a similarity analysis. The similarity analysis may be based on a similarity metric, such as, but not limited to, a Manhattan distance, a Euclidean distance, a cosine similarity, a Jaccard similarity, and a Hamming similarity. By way of an example, the GenAI model 212 may analyze each of the set of input requirements 216 to assign hierarchy rank based on uniqueness, distinct functionality, and the like. Further, based on analysis, the GenAI model 212 may assign the rank to each of the set of input requirements 216.

Further, for each of the one or more batches, the uniqueness score calculating module 208 may select a second predefined number of input requirements from the first predefined number of input requirements based on the rank. Further, the uniqueness score calculating module 208 may form new hierarchy batches from the second predefined number of input requirements for a next iteration of the one or more iterations. It should be noted that each of the new hierarchy batches may include a first predefined number of the selected input requirements.

Further, for each of the set of input requirements 216, the uniqueness score calculating module 208 may calculate the uniqueness score of the input requirement based on associated hierarchy ranks at the one or more iterations. The uniqueness score may be in a range of (0-1).

In some embodiments, the GenAI model 212 may also provide an assessment (or comments) along with scores corresponding to the relevancy, redundancy (or reusability), and uniqueness criteria. In continuation with the above example, the scores may be computed in a range of 0-10. For the input requirement ‘Moweaqua’, the relevancy score (or traceability score) may be ‘6’ out of ‘10’. The corresponding assessment for ‘New_Req_A’ compared to the existing requirement cluster R1 for relevancy may be ‘Biometrics extends the login functionality by introducing a new authentication method’. The corresponding assessment for ‘New_Req_A’ compared to the existing requirement cluster R2 for relevancy may be ‘Biometrics login attempts can be logged for audit purpose’.

Additionally, for the input requirement ‘New_Req_A’, the reusability score may be ‘4’ out of ‘10’. The corresponding assessment for ‘New_Req_A’ compared to the existing requirement cluster R1 for redundancy may be ‘The validation logic (i.e., ‘Existing_Req1’) can be adapted for biometric inputs’. The corresponding assessment for ‘New_Req_A’ compared to the existing requirement cluster R2 for redundancy may be ‘Logging mechanisms (i.e., ‘Existing_Req3’) can be reused to log biometric login attempts’. It should be noted that the reusability score may be subtracted from 10 to calculate the redundancy score. Thus, the redundancy score may be ‘6’ out of ‘10’.

Additionally, for the input requirement ‘New_Req_A’, the uniqueness score may be ‘8’ out of ‘10’. The corresponding assessment for ‘New_Req_A’ for uniqueness may be ‘Introduces novel elements (such as fingerprint and facial recognition) which are not present in the existing requirements’. Each of the predefined criteria may be assigned a weight. The weight for the relevancy score may be 0.5, the weight for the redundancy score (or reusability score) may be 0.3, and the weight for the uniqueness score may be 0.2. Thus, the weighted average score for the input requirement ‘New_Req_A’may be calculated as ‘6.4’.

Similarly, for the input requirement ‘New_Req_B’, the relevancy score (or traceability score) may be ‘8’ out of ‘10’. The corresponding assessment for ‘New_Req_B’ compared to the existing requirement cluster R2 for relevancy may be ‘Blocking login attempts after repeated failures enhances the existing functionality of flagging failed attempts.’.

Additionally, for the input requirement ‘New_Req_B’, the reusability score may be ‘9’ out of ‘10’. The corresponding assessment for ‘New_Req_B’ compared to the existing requirement cluster R2 for redundancy may be ‘The logic for tracking failed attempts can be extended to include blocking functionality’.

Additionally, for the input requirement ‘New_Req_B’, the uniqueness score may be ‘4’ out of ‘10’. The corresponding assessment for ‘New_Req_B’ for uniqueness may be ‘Adds new behavior (blocking login) but builds on existing concepts’. The weighted average score for the input requirement ‘New_Req_B’ may be calculated as ‘5.1’.

Similarly, for the input requirement ‘New_Req_C’, the relevancy score (or traceability score) may be ‘8’ out of ‘10’. The corresponding assessment for ‘New_Req_C’ compared to the existing requirement cluster R2 for relevancy may be ‘The requirement is a direct match with the existing functionality’.

Additionally, for the input requirement ‘New_Req_C’, the reusability score may be ‘10’ out of ‘10’. The corresponding assessment for ‘New_Req_C’ compared to the existing requirement cluster R2 for redundancy may be ‘Fully reusable because the functionality already exists’.

Additionally, for the input requirement ‘New_Req_C’, the uniqueness score may be ‘1’ out of ‘10’. The corresponding assessment for ‘New_Req_C’ for uniqueness may be ‘Adds no new functionality since it duplicates an existing requirement’. The weighted average score for the input requirement ‘New_Req_C’ may be calculated as ‘4.2’.

Further, the priority of implementation determining module 210 may determine a priority of implementation for each of the set of input requirements 216 based on the weighted average score. The priority for implementation corresponds to an ordered list of the set of input requirements 216 based on the weighted average score. In an embodiment, the priority for implementation may be provided in the form of a table.

In continuation with the above example, the input requirement ‘New_Req_A’ may be implemented first among the other two input requirements due to its highest weighted average score (i.e., moderate relevancy score, not much usable feature, and highly uniqueness score). The input requirement ‘New_Req_B’ may be implemented second because it enhances the existing functionality with the minimal adaptation. The input requirement ‘New_Req_C’ may be implemented at last because it may not have any unique feature.

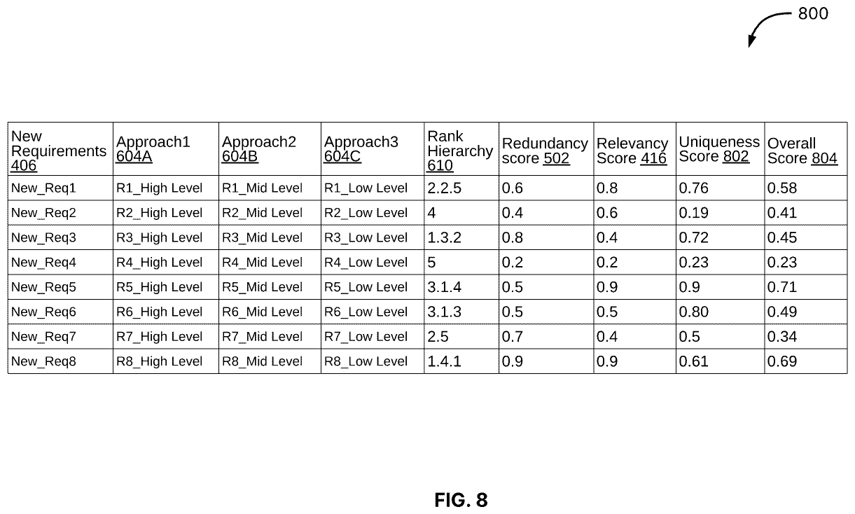

Further, upon determining the priority of implementation for each of the set of input requirements 216, the priority of implementation determining module 210 may generate a requirement analysis report 218 based on the priority of implementation for the set of input requirements. This is further explained in greater detail in conjunction with FIG. 8.

It should be noted that all such aforementioned modules 202-214 may be represented as a single module or a combination of different modules. Further, as will be appreciated by those skilled in the art, each of the modules 202-214 may reside, in whole or in parts, on one device or multiple devices in communication with each other. In some embodiments, each of the modules 202-214 may be implemented as dedicated hardware circuit comprising custom application-specific integrated circuit (ASIC) or gate arrays, off-the-shelf semiconductors such as logic chips, transistors, or other discrete components. Each of the modules 202-214 may also be implemented in a programmable hardware device such as a field programmable gate array (FPGA), programmable array logic, programmable logic device, and so forth. Alternatively, each of the modules 202-214 may be implemented in software for execution by various types of processors (e.g., processor 104). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for determining a priority of implementation for input requirements. For example, the exemplary system 100 and the associated computing device 102, may determine a priority of implementation for input requirements, by the processes discussed herein. In particular, as will be appreciated by those of ordinary skill in the art, control logic and/or automated routines for performing the techniques and steps described herein may be implemented by the system 100 and the computing device 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some or all of the processes described herein may be included in the one or more processors on the system 100.

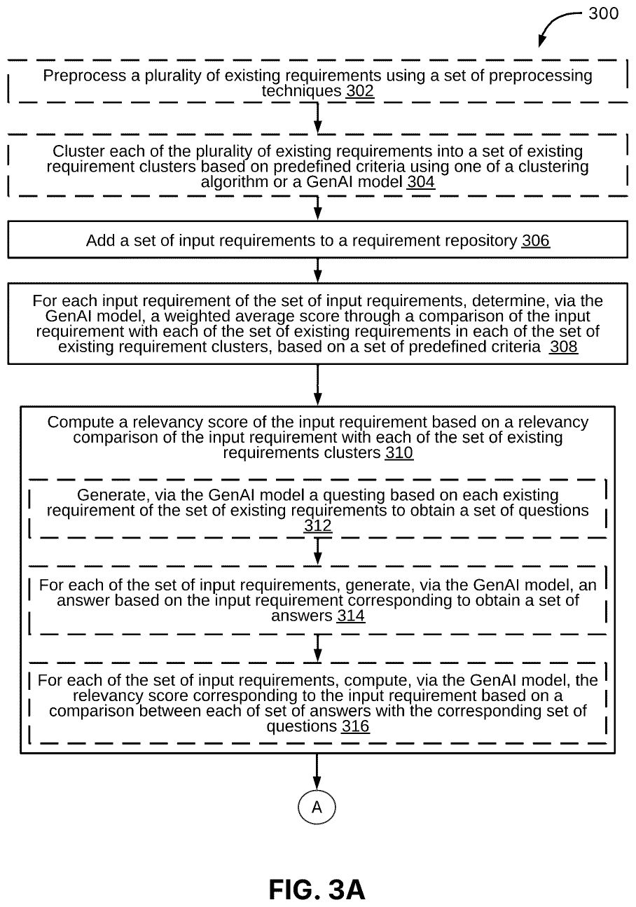

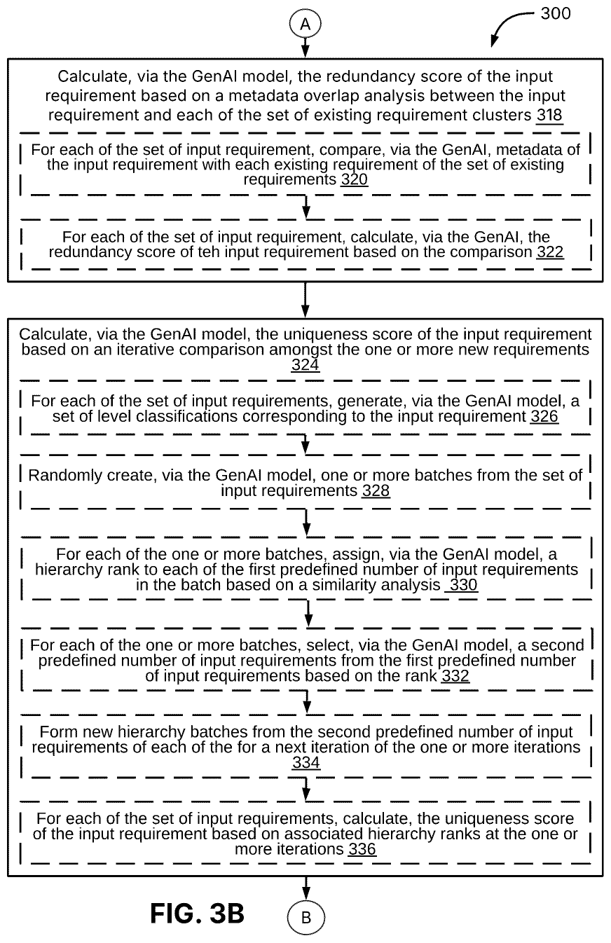

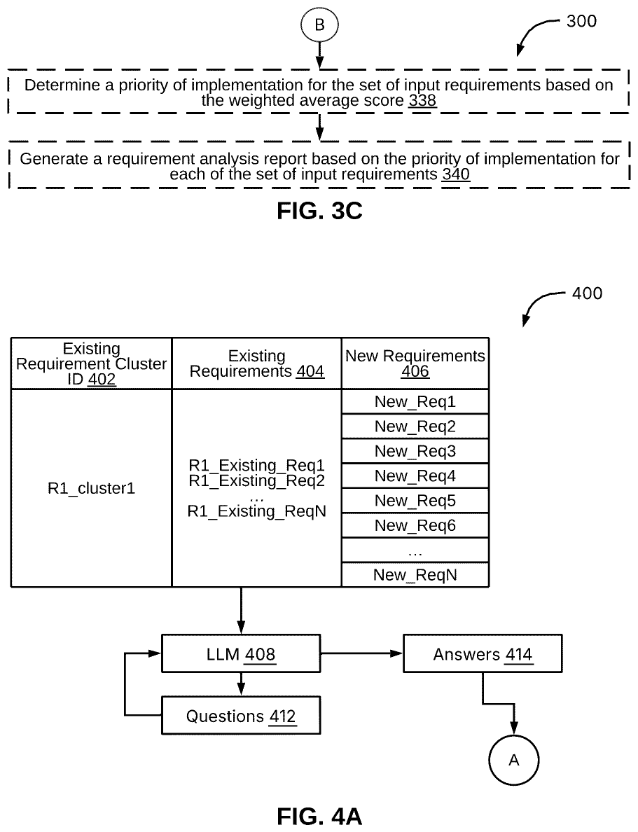

Referring now to FIGS. 3A, 3B, and 3C, an exemplary process 300 for determining the priority of implementation for the input requirements is depicted via a flow chart, in accordance with some embodiments of the present disclosure. The process 300 may be implemented by the computing device 102 of the system 100. In some embodiments, the process 300 may include preprocessing, by a clustering module (such as the clustering module 202), a plurality of existing requirements using a set of preprocessing techniques, at step 302. The plurality of existing requirements may be received from existing projects, existing documentation, reports, and memory archives. Further, upon receiving the plurality of existing requirements, the plurality of existing requirements may be stored in a requirement repository (such as the requirement repository 214). In some embodiments, the plurality of existing requirements may be pre-stored in the requirement repository.

Further, upon preprocessing the plurality of existing requirements, the process 300 may include clustering, by the clustering module, each of the plurality of existing requirements into a set of existing requirement clusters based on predefined criteria using one of a clustering algorithm or a GenAI model (such as the GenAI model 212), at step 304. Each of the set of existing requirement clusters may include a set of existing requirements. Further, the set of existing requirement clusters may be stored in the requirement repository.

Further, upon clustering, the process 300 may include adding, by a relevancy score computing module (such as the relevancy score computing module 204), a set of input requirements (such as the set of input requirements 216) to the requirement repository, at step 306. The set of input requirements may be received from a stakeholder (e.g., a project team member, customers, a software developer, a programmer, and the like).

Further, for each input requirement of the set of input requirements, the process 300 may include determining, by the relevancy score computing module via the GenAI model, a weighted average score through a comparison of the input requirement with each of the set of existing requirements in each of the set of existing requirement clusters, based on a set of predefined criteria, at step 308. The set of predefined criteria may include at least one of relevancy, redundancy, and uniqueness. The step 308 may include a step 310. The comparison of the input requirement based on a predefined criteria of relevancy, the process 300 may include computing, via the GenAI model, a relevancy score of the input requirement based on a relevancy comparison of the input requirement with each of the set of existing requirement clusters, at step 310. The step 310 may include steps 312, 314, and 316.

To compute the relevancy score of the input requirement, for each of the set of existing requirement clusters, the process 300 may include generating, by the relevancy score computing module via the GenAI model, a question based on each existing requirement of the set of existing requirements to obtain a set of questions, at step 312.

Further, for each of the set of input requirements, the process 300 may include generating, by the relevancy score computing module via the GenAI model, an answer based on the input requirement corresponding to each of the set of questions, to obtain a set of answers, at step 314.

Further, for each of the set of input requirements, the process 300 may include computing, by the relevancy score computing module via the GenAI model, the relevancy score corresponding to the input requirement based on a comparison between each of the set of answers with the corresponding set of questions, at step 316.

Further, the comparison of the input requirement based on a predefined criteria of redundancy, the process 300 may include calculating, by a redundancy score calculating module (such as the redundancy score calculating module 206) via the GenAI model, a redundancy score of the input requirement based on a metadata overlap analysis between the input requirement and each of the set of existing requirement clusters, at step 318. The step 318 may include steps 320, and 322.

To calculate the redundancy score, for each of the set of existing requirement clusters, the process 300 may include comparing, by the redundancy score calculating module via the GenAI model, for each of the set of input requirements, metadata of the input requirement with each existing requirement of the set of existing requirements, at step 320. It should be noted that the metadata may include description content associated with the input requirement.

Further, for each of the set of input requirements, the process 300 may include calculating, by the redundancy score calculating module via the GenAI model, the redundancy score of the input requirement based on the comparison, at step 322.

Further, the comparison of the input requirement based on a predefined criteria of uniqueness, the process 300 may include calculating, by a uniqueness score calculating module (such as the uniqueness score calculating module 208) via the GenAI model, a uniqueness score of the input requirement based on an iterative comparison amongst the one or more new requirements, at step 324. The step 324 may include steps 326, 328, 330, 332, 334, and 336.

To calculate the uniqueness score of the input requirement, for each of the set of input requirements, the process 300 may include generating, by the uniqueness score calculating module via the GenAI model, a set of level classifications corresponding to the input requirement, at step 326. The set of level classifications may include a high level classification, a medium level classification, and a low level classification.

Further, upon generating the set of level classifications, the process 300 may include randomly creating, by the uniqueness score calculating module via the GenAI model, one or more batches from the set of input requirements, at step 328. Each of the one or more batches may include a first predefined number of input requirements.

Further, for each of one or more iterations, the process 300 may include assigning, by the uniqueness score calculating module via the GenAI model, for each of the one or more batches, a hierarchy rank to each of the first predefined number of input requirements in the batch based on a similarity analysis, at step 330.

Further, for each of the one or more batches, the process 300 may include selecting, by the uniqueness score calculating module, a second predefined number of input requirements from the first predefined number of input requirements based on the rank, at step 332.

Further, the process 300 may include forming, by the uniqueness score calculating module, new hierarchy batches from the second predefined number of input requirements for a next iteration of the one or more iterations, at step 334. It should be noted that each of the new hierarchy batches may include a first predefined number of the selected input requirements.

Further, for each of the set of input requirements, the process 300 may include calculating, by the uniqueness score calculating module, the uniqueness score of the input requirement based on associated hierarchy ranks at the one or more iterations, at step 336.

Further, upon determining the weighted average score, the process 300 may include determining, by a priority of implementation determining module (such as the priority of implementation determining module 210), a priority of implementation for the set of input requirements based on the weighted average score, at step 338. The priority for implementation corresponds to an ordered list of the set of input requirements based on the weighted average score.

Further, upon determining the priority of implementation for the set of input requirements, the process 300 may include generating, by the priority of implementation determining module, a requirement analysis report (such as the requirement analysis report 218) based on the priority of implementation for the set of input requirements, at step 340.

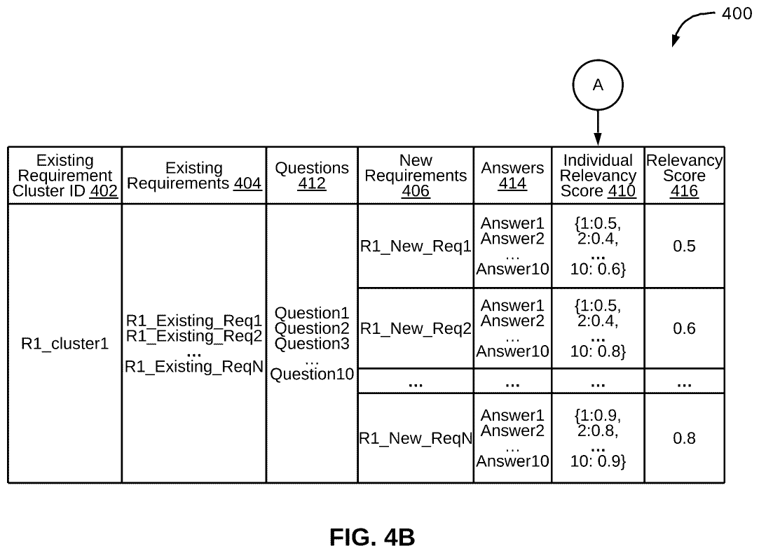

Referring now to FIGS. 4A and 4B, a detailed exemplary process 400 for computing the relevancy score for the input requirements is depicted via a flowchart, in accordance with some embodiments of the present disclosure. Initially, the clustering module 202 may receive a plurality of existing requirements from previous projects stored in the requirement repository 214. The plurality of existing requirements may be pre-stored in the requirement repository 214. Once the plurality of existing requirements is received, the clustering module 202 may preprocess the plurality of existing requirements using a set of preprocessing techniques. By way of an example, the clustering module 202 may preprocess the plurality of existing requirements to prepare the plurality of existing requirements for further analysis (e.g., machine analysis). To prepare the plurality of existing requirements for further analysis, the clustering module 202 may remove noise (such redundant information, an ambiguous term, repetitive term, and the like) from description of the plurality of existing requirements to ensure clarity. Additionally, the clustering module 202 may convert each of the plurality of existing requirements into a vector format (e.g., PDF) for further analysis.

Further, upon preprocessing, the clustering module 202 may cluster each of the plurality of existing requirements into a set of existing requirement clusters based on predefined criteria using a clustering algorithm (e.g., a K means clustering). Each of the existing requirement clusters may include a set of existing requirements. Further, the relevant score computing module 204 may add a set of input requirements (such as the set of input requirements 216) to the requirement repository 214. The set of input requirements may be analogous to a set of new requirements. The set of input requirements may be received from a stakeholder (e.g., a software developer) in a natural language.

By way of an example, the requirement repository 214 may include a column for a cluster requirement unique identifier (ID) 402, a column for an existing requirement 404, and a column for new requirements 406. The cluster requirement ID 402 may be ‘R1_Cluster1’. The cluster requirement ID 402 may include a set of existing requirements 404. The set of existing requirements 404 may include an existing requirements ‘R1_Existing_Req1’, ‘R1_Existing_Req2’, ‘R1_Existing_Req3’, ‘R1_Existing_Req4’, ‘R1_Existing_Req5’, upto R1_Existing_ReqN’. The new requirement 406 may include a plurality of new requirements such as ‘New_Req1’, ‘New_Req2’, ‘New_Req3’, ‘New_Req4’, ‘New_Req5’, upto ‘New_ReqN’.

Further, for each of the set of new requirements, the relevancy score computing module 204 may determine, via a LLM 408 (such as the GenAI model 212), a weighted average score through a comparison of the new requirement with each of the set of existing requirements in each of the set of existing requirement clusters, based on a set of predefined criteria. To perform a comparison of the new requirement based on a predefined criteria of relevancy, the relevancy score computing module 204 may compute a relevancy score 416 of the new requirement based on a relevancy comparison of the input requirement with each of the set of existing requirement clusters.

In continuous with the above example, for the cluster requirement ID 402 ‘R1_Cluster1’, the LLM 408 may generate a question based on each existing requirement of the set of existing requirements 404 to obtain a set of questions 412. The set of questions 412 may include a ‘Question 1’, a ‘Question 2’, a ‘Question 3’, a ‘Question 4’, . . . , and a ‘Question 10’. By way of an example, the ‘Question 1’ may be generated from the existing requirement ‘R1_Existing_Req1’, the ‘Question 2’ may be generated from the existing requirement 404 ‘R1_Existing_Req2’, the ‘Question 3’ may be generated from the existing requirement 404 ‘R1_Existing_Req3’. In the same manner, each of remaining of the set of questions 412 may be generated from the corresponding existing requirement 404.

Further, upon generating the set of questions 412, the LLM 408 may generate a set of answers 414 corresponding to each of the set of questions 412 from the set of input requirements 406 for each existing requirement 404 corresponding to the cluster requirement ID 402 ‘R1_Cluster1’.

In continuation with the above example, from the new requirement 406 ‘New_Req1’, a set of answers 414 (e.g., 10 answers for each 10 questions) may be generated corresponding to each of the set of questions 412 (i.e., 10 questions) through the LLM 408. For example, an answer 414 ‘1’ may be generated for the question 412 ‘1’, an answer 414 ‘2’ may be generated for the question 412 ‘2’, etc.

Similarly, from the new requirement 406 ‘new_req2’, the set of answers 414 (i.e., 10 answers) may be generated for each of the set of questions 412 (i.e., 10 questions) through the LLM 408. In the same manner, from the new requirement 406 ‘New_Req1’, the set of answers 414 may be generated for each of the set of questions 412 through the LLM 408.

Further, upon generating the set of answers 414 for each set of questions 412, the LLM 408 may compare (or match) each question of the set of questions 412 with each answer of the set of answers 414 derived from the set of new requirements 406 to compute the relevancy score 416. The LLM 408 may compute the relevancy score 416 for each new requirement based on an alignment with the existing requirements. The relevancy score 416 may be used to analyse how well the new requirement is related to the exiting requirement.

In continuation with the above example, for the new requirement 406 ‘New_Req1’, an individual relevancy score 410 corresponding to the answer 414 ‘1’ may be ‘0.5’, the individual relevancy score 410 corresponding to the answer 414 ‘2’ may be ‘0.4’, and the individual relevancy score 410 corresponding to the answer 414 ‘10’ may be ‘0.6’.

For the new requirement 406 ‘New_Req2’, the individual relevancy score 410 corresponding to the answer 414 ‘1’ may be ‘0.5’, the individual relevancy score 410 corresponding to the answer 414 ‘2’ may be ‘0.4’, and the individual relevancy score 410 corresponding to the answer 414 ‘10’ may be ‘0.8’.

For the new requirement 406 ‘New_ReqN’, the individual relevancy score 410 corresponding to the answer 414 ‘1’ may be ‘0.9’, the individual relevancy score 410 corresponding to the answer 414 ‘2’ may be ‘0.8’, and the individual relevancy score 410 corresponding to the answer 414 ‘10’ may be ‘0.9’.

Further, the LLM 408 may calculate the relevancy score 416 for each new requirement 406 based on an average of the individual relevancy scores for that new requirement 406. In continuation with the above example, for the new requirement 406 ‘New_Req1’, the relevancy score 416 may be ‘0.5’. For the new requirement 406 ‘New_Req2’, the relevancy score 416 may be ‘0.6’. For the new requirement 406 ‘New_ReqN’, the relevancy score 416 may be ‘0.8’.

It should be noted that higher relevancy score 416 value may indicate better traceability and relevance corresponding to the input requirement. In continuation of the above example, the input requirement 406 ‘New_ReqN’ may indicate better traceability and relevance among the other input requirements 406.

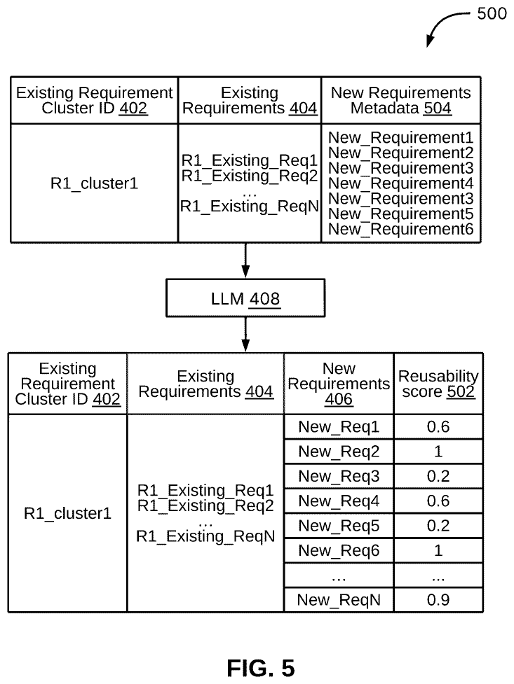

Referring now to FIG. 5, a detailed exemplary process 500 for calculating a reusability score 502 for the input requirements is illustrated via a flow chart, in accordance with some embodiments of the present disclosure. FIG. 5 is explained in conjunction with FIG. 4. The comparison of the input requirement based on a predefined criteria of redundancy, in such cases, the redundancy score calculating module 206 may calculate, via the LLM 408, the reusability score 502 of the input requirement based on a metadata overlap analysis between the input requirement and each of the set of existing requirement clusters.

In continuation with the above example, the same requirement repository 214 (as referred to FIG. 4) may be used to calculate the reusability score 502 for the input requirements. For example, the input requirement 406 ‘New_Req1’ may include the metadata 504 ‘New_Requirement1’, the input requirement 406 ‘New_Req2’ may include the metadata 504 ‘New_Requirement2’, and the input requirement 406 ‘New_Req3’ may include the metadata 504 ‘New_Requirement3’.

Further, the LLM 408 may compare the metadata 504 corresponding to each input requirement 406 with the existing requirements 404 of each of the set of existing requirement clusters based on the overlap analysis using the LLM 408. For example, the metadata 504 ‘New_Requirement1’ corresponding to the input requirement 406 ‘New_Req1’ may be compared with each of the set of existing requirements 404 in the existing requirement cluster ‘R1_cluster1’. Similarly, each metadata 504 corresponding to the input requirement 406 may be compared with each existing requirement of the set of existing requirements 404 in the existing requirement cluster ‘R1_cluster1’.

Further, the LLM 408 may calculate the reusability score 502 for each input requirements 406. The reusability score 502 of the input requirement may measure how much the new requirement may be different from the existing requirements.

In continuation with the above example, for the input requirement 406 ‘New_Req1’, the reusability score 502 may be ‘0.6’. For the input requirement 406 ‘New_Req2’, the reusability score 502 may be ‘1’. For the input requirement 406 ‘New_Req3’, the reusability score 502 may be ‘0.2’. For the input requirement 406 ‘New_Req4’, the reusability score 502 may be ‘0.6’.

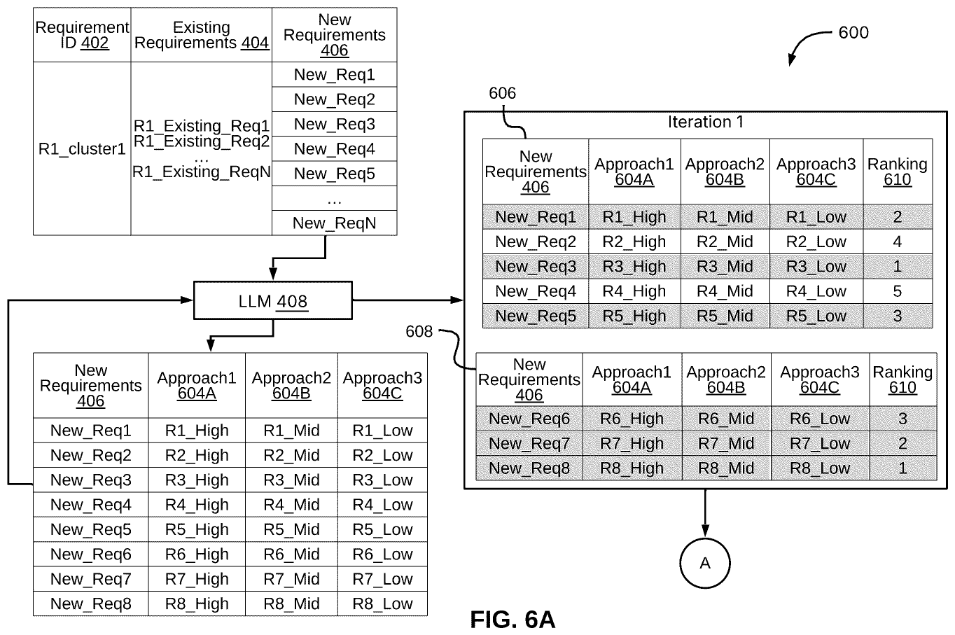

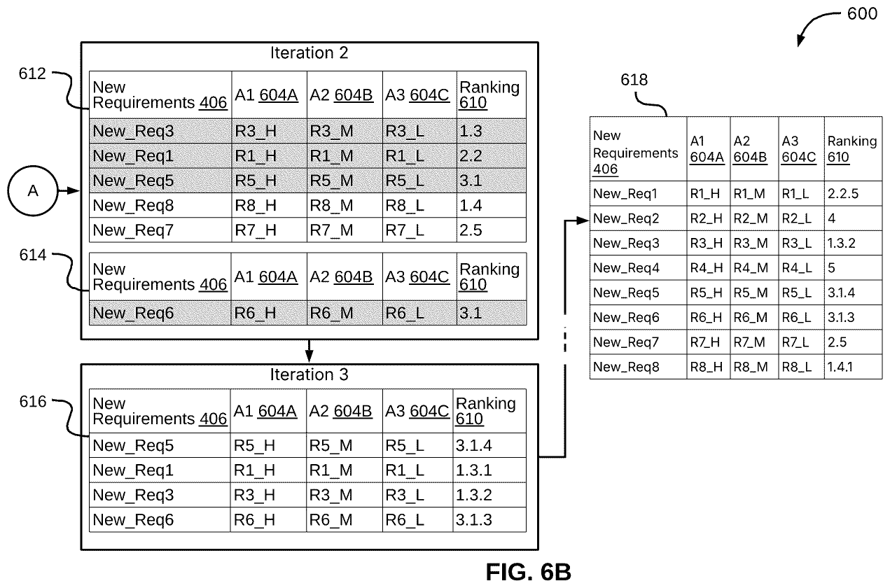

Referring now to FIGS. 6A and 6B, a detailed exemplary process 600 for calculating a uniqueness score 602 for the input requirements is depicted via a flow chart, in accordance with some embodiments of the present disclosure. FIG. 6 is explained in conjunction with FIGS. 4A-B and 5. Initially, the uniqueness score calculating module 208 may calculate, via the LLM 408, the uniqueness score 602 of the input requirement based on an iterative comparison amongst the one or more new requirements. For ease of explanation, the set of input requirements 406 may include eight input requirements. The eight input requirements 406 may be ‘New_Req1’, ‘New_Req2’, ‘New_Req3’, ‘New_Req4’, ‘New_Req5’, ‘New_Req6’, ‘New_Req7’, and ‘New_Req8’.

To calculate the uniqueness score 602, for each of the eight input requirements 406, LLM 408 may generate a set of level classifications corresponding to the input requirement. The set of level classifications may include a high level classification, a medium level classification, and a low level classification. In other words, each of the eight input requirements 406 may be breaking down into three levels of approach (a high level approach 604A, a mid-level approach 604B, and a low level approach 604C). It should be noted that the high level approach 604A may be analogous to the high level classification, the mid-level approach 604B may be analogous to the medium level classification, and the low level approach 604C may be analogous to the low level classification.

In continuation with the above example, the input requirement 406 ‘New_Req1’ may be broken down into the high level approach 604A as ‘R1_High_Level’, mid-level approach 604B as ‘R1_Medium_Level’, and the low level approach 604C as ‘R1_Low_Level’. The input requirement 406 ‘New_Req2’ may be broken down into the high level approach 604A as ‘R2_High_Level’, mid-level approach 604B as ‘R2_Medium_Level’, and the low level approach 604C as ‘R2_Low_Level’. The input requirement 406 ‘New_Req3’ may be broken down into the high level approach 604A as ‘R3_High_Level’, mid-level approach 604B as ‘R3_Medium_Level’, and the low level approach 604C as ‘R3_Low_Level’.

Similarly, the remaining input requirements 406 may also be broken down into the three approaches. Further, the LLM 408 may randomly create one or more batches from the set of input requirements 406. Each of the one or more batches may include a first predefined number of input requirements 406. In particular, if more than five input requirements are provided, the LLM 408 may accordingly split the set of input requirements into one or more batches, each with a maximum of 5 input requirements.

In continuation with the above example, the eight input requirements 406 may be split into two batches (e.g., a batch 606 and a batch 608) through the LLM 408. For example, the batch 606 may include five input requirements 406 (i.e., the ‘New_Req1’, the ‘New_Req2’, the ‘New_Req3’, the ‘New_Req4’, and the ‘New_Req5’). On the other hand, the batch 608 may include the remaining three input requirements 406 (i.e., the ‘New_Req6’, the ‘New_Req7’, and the ‘New_Req8’).

Further, in a first iteration, the LLM 408 may assign a hierarchy rank 610 to each of the first predefined number of input requirements in the batch based on a similarity analysis (e.g., a Euclidean distance) of the high level approach 604A with the existing requirements 404. The hierarchy rank 610 may be assigned based on uniqueness for each input requirements.

In continuation with the above example, for example, based on the similarity analysis of the high level approach 604A, in the batch 606, the input requirement 406 ‘New_Req1’ may be assigned the rank 610 ‘2’, the ‘New_Req2’ may be assigned the rank 610 ‘4’, the ‘New_Req3’ may be assigned the rank 610 ‘1’, the ‘New_Req4’ may be assigned the rank 610 ‘5’, and ‘New_Req5’ may be assigned the rank 610 ‘3’. Additionally, in the batch 608, the input requirement 406 ‘New_Req6’ may be assigned the rank 610 ‘3’, the ‘New_Req7’ may be assigned the rank 610 ‘2’, and the ‘New_Req8’ may be assigned the rank 610 ‘1’.

Further, for each of the one or more batches of the first iteration, the LLM 408 may select a second predefined number of input requirements from the first predefined number of input requirements based on the rank 610. Further, the LLM 408 may use the selected input requirements to randomly create one or more new batches, each with a maximum of the first predefined number of input requirements.

In continuation with the above example, the LLM 408 may select top three ranked input requirements 406 from each of the two batches for the second iteration to make new batches of maximum five input requirements. Based on the rank 610 assigned in the first iteration, from the batch 606, the top three ranked input requirements 406 (i.e., the ‘New_Req3’ with the rank 610 ‘1’, the ‘New_Req1’ with the rank 610 ‘2’, and the ‘New_Req5’ with the rank 610 ‘3’) may be selected by the LLM 408 for the second iteration. Similarly, from the batch 608, top three ranked input requirements 406 (i.e., the ‘New_Req8’ with the rank 610 ‘1’, the ‘New_Req7’ with the rank 610 ‘2’) may be selected by the LLM 408 for the second iteration. Thus, a total of 6 input requirements may be selected for the second iteration. For the second iteration, a batch 612 and a batch 614 may be created. The batch-1 612 may include 5 input requirements 406 (e.g., the ‘New_Req3’, the ‘New_Req1’, the ‘New_Req5’, the ‘New_Req8’, the ‘New_Req7’). Similarly, a batch-2 614 may include one input requirement 406 (e.g., the ‘New_Req6).

Further, upon creating the one or more new batches, the LLM 408 may assign the hierarchy rank 610 for the second iteration to each of the first predefined number of input requirements in the batch based on the similarity analysis of the mid-level approach 604B with the existing requirements 404.

In continuation with the above example, in the batch 612, the input requirement 406 ‘New_Req3’ may be assigned the rank 610 ‘1.2’, the ‘New_Req1’ may be assigned the rank 610 ‘2.2’, the ‘New_Req5’ may be assigned the rank 610 ‘3.1’, the ‘New_Req8’ may be assigned the rank 610 ‘1.4’, and ‘New_Req7’ may be assigned the rank 610 ‘2.5’. Similarly, in the batch 614, the input requirement 406 ‘New_Req6’ may be assigned the rank 610 ‘3.1’. It should be noted that the rank 610 assigned at the second iteration also includes the rank 610 assigned at the first iteration. For example, the rank 610 of ‘1.2’ denotes that the input requirement was assigned a rank 1 at the first iteration and a rank 2 at the second iteration. Thus, the rank 610 is a hierarchy rank for the input requirement.

Similarly, for a third iteration, the LLM 408 may again select the second predefined number of input requirements (i.e., top three ranked input requirements 406) from each of the one or more new batches (i.e., the batch 612, and the batch 614). Further, upon selection, the LLM 408 may randomly create one or more new batches from the selected input requirements for the third iterations. Each of the one or more new batches may include a maximum of the first predefined number of input requirements. The LLM 408 may then assign the rank 610 to each input requirements 406 based on the similarity analysis of the low-level approach 604C with the existing requirements 404.

In continuation with the above example, from the batch 612, top three ranked input requirements 406 (i.e., the ‘New_Req5’, the ‘New_Req1’, and the ‘New_Req3’) may be selected by the LLM 408. Similarly, from the batch 614, the input requirement 406 the ‘New_Req6’ may be selected. Further, in the batch 616, the input requirement 406 ‘New_Req5’ may be assigned the rank 610 ‘3.1.4’, the ‘New_Req1’ may be assigned the rank 610 ‘1.3.1’, the ‘New_Req3’ may be assigned the rank 610 ‘1.3.2’, and the ‘New_Req6’may be assigned the rank 610 ‘3.1.3’.

Further, upon third iteration, a final hierarchy rank table 618 may be generated. The final hierarchy rank table 618 may include the rank 610 assigned to each of the input requirements 406. Following are some exemplary ranks assigned to each of the input requirements 406 by the LLM 408.

For example, for the input requirement 406 ‘New_Req1’, the rank 610 may be ‘2.2.5’. For the input requirement 406 ‘New_Req2’, the rank 610 may be ‘4’. For the input requirement 406 ‘New_Req3’, the rank 610 may be ‘1.3.2’. For the input requirement 406 ‘New_Req4’, the rank 610 may be ‘5’. For the input requirement 406 ‘New_Req5’, the rank 610 may be ‘3.1.4’.

Further, the LLM 408 may calculate the uniqueness score 602 for each input requirements of the set of input requirements 406 based on the rank 610 after the third iteration. The uniqueness score 602 may be calculated using equation (1).

$$Uniqueness score = [ Sum ( {Rank}_{i} * {GP}_{i} ) ] / [ Sum ( GP ) ] \qquad ( 1 )$$

Where, GP is a Geometric Progression aₙ=a.r⁽ⁿ⁻¹⁾, where ‘a’ corresponds to a first value, ‘n’ corresponds to the number of iterations, ‘r’ corresponds to the common ratio. Ranki corresponds to a rank value at i^{th} iteration (i.e., n=i).

For example, ‘a’ may be ‘1’, ‘n’ may be ‘3’, and ‘r’ may be ‘2’. Thus, the GP for the first iteration may be ‘0.5’, the GP for the second iteration may be ‘1’, and the GP for the third iteration may be ‘2’. The uniqueness score may be calculated using the equation (1). For an input requirement with the rank 610 ‘2.2.5’, the uniqueness score 602 may be calculated as follows.

$$[ ( 2 * 0.5 ) + ( 2 * 1 ) + ( 5 * 2 ) ] / 3.5 = 3.71$$

Further, a normalized uniqueness score may be calculated as (uniqueness score/5). Thus, in the above example, the normalized uniqueness score may be ‘0.76’.

Similarly, the uniqueness score 602 for each of the set of input requirements 406 may be calculated based on the above mentioned formula. For input requirements that were not ranked for an iteration, the rank value for that iteration may be taken as ‘0’. For example, for the input requirement with a rank 610 of ‘1.

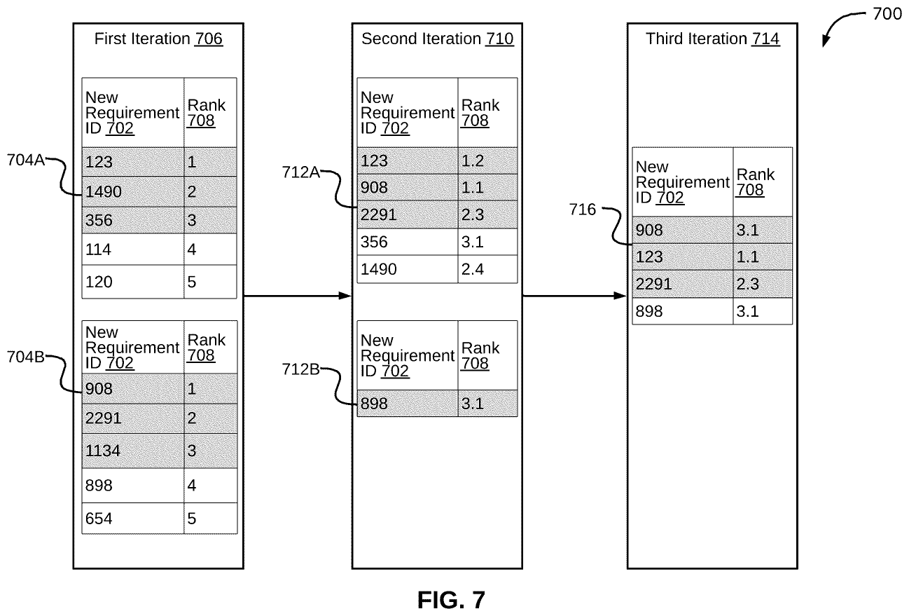

Referring now to FIG. 7, a detailed exemplary process 700 for assigning the hierarchy rank to the input requirements is depicted via a flowchart, in accordance with an embodiment of the present disclosure. FIG. 7 is explained in conjunction with FIG. 4-6. Initially, for each of the set of input requirements 406, the LLM 408 may generate a set of level classifications corresponding to the input requirement. This is already explained in greater detail in conjunction with FIGS. 6A-B. For ease of explanation, the set of input requirement 406 may include 10 requirements.

Further, the LLM 408 may provide a requirement unique identifier (ID) 702 to each of the input requirements 406. The respective requirement IDs 702 of the set of input requirements may be ‘123’, ‘1490’, ‘356’, ‘114’, ‘120’, ‘908’, ‘2291’, ‘1134’, ‘898’, and ‘654’.

Further, the LLM 408 may split the set of 10 requirement IDs into two batches (a batch 704A, and a batch 704B). Each batch may include a set of five input requirements. For example, the batch 704A may include the requirement IDs ‘123’, ‘1490’, ‘356’, ‘114’, and ‘120’. Similarly, the batch 704B may include the requirement IDs ‘908’, ‘2291’, ‘1134’, ‘898’, and ‘654’.

Further, in a first iteration 706, the LLM 408 may assign a hierarchy rank 708 (as analogous to the rank 610) to each of the set of new requirement IDs 702 based on a similarity analysis. In continuation with the above example, in the batch 704A, the requirement ID 702 ‘123’ may be assigned a rank 708 ‘1’, the requirement ID 702 ‘1490’ may be assigned a rank 708 ‘2’, the requirement ID 702 ‘356’ may be assigned a rank 708 ‘3’, the requirement ID 702 ‘114’ may be assigned a rank 708 ‘4’, and the requirement ID 702 ‘120’ may be assigned a rank 708 ‘5’.

Similarly, in the batch 704B, the requirement ID 702 ‘908’ may be assigned a rank 708 ‘1’, the requirement ID 702 ‘2291’ may be assigned a rank 708 ‘2’, the requirement ID 702 ‘1134’ may be assigned a rank 708 ‘3’, the requirement ID 702 ‘898’ may be assigned a rank 708 ‘4’, and the requirement ID 702 ‘654’ may be assigned a rank 708 ‘5’.

Further, for a second iteration 710, the LLM 408 may select top three ranked requirement IDs 702 from each batch. Further, upon selection, the LLM 408 may randomly create new batches of up to five requirement IDs 702 each from the selected requirement IDs. In continuation with the above example, a batch 712A may include the requirement IDs ‘123’, ‘908’, ‘2291’, ‘356’, and ‘1490’ and a batch 712B may include the requirement ID 702 ‘898’.

Further, the LLM 408 may assign the hierarchy rank 708 to each of the requirement IDs 702 in the second iteration 710. For example, in the batch 712A, the requirement ID 702 ‘123’ may be assigned a rank 708 ‘1.2’, the requirement ID 702 ‘908’ may be assigned a rank 708 ‘1.1’, the requirement ID 702 ‘2291’ may be assigned a rank 708 ‘2.3’, the requirement ID 702 ‘356’ may be assigned a rank 708 ‘3.1’, and the requirement ID 702 ‘1490’ may be assigned a rank 708 ‘2.4’. In the same manner, in batch 712B, the requirement ID 702 ‘898’ may be assigned a rank 708 ‘3.1’.

Further, for a third iteration 714, the LLM 408 may select top three ranked requirements IDs 702 from each batch (i.e., the batch 712A, and the batch 712B) through the LLM 408 based on the similarity analysis. As will be appreciated, since the batch 712B includes one requirement ID, the LLM 408 may select just one requirement ID from the batch 712B instead of 3. Upon selection, the LLM 408 may randomly form a new batch of up to five requirement IDs from the selected requirement IDs. The new batch 716 may include requitement IDs 702 ‘908’, ‘123’, ‘2291’, and ‘898’. Further, the LLM 408 may assign the third hierarchy rank 708 to each requirement IDs 702 through the LLM 408 based on the similarity analysis.

In continuation with the above example, in the batch 716, the requirement ID 702 ‘908’ may be assigned the rank 708 ‘1.1.1’, the requirement ID 702 ‘123’ may be assigned the rank 708 ‘1.2.3’, the requirement ID 702 ‘2291’ may be assigned the rank 708 ‘2.3.2’. Further, based on the rank, the uniqueness score for the input requirements may be calculated using the LLM 408.

Referring now to FIG. 8, an exemplary requirement analysis report 800 is illustrated, in accordance with some embodiments of the present disclosure. FIG. 8 is explained in conjunction with FIG. 4-7. The requirement analysis report 800 may be presented in a tabular format. The requirement analysis report 800 may include the priority of implementation of the input requirements 406. The requirement analysis report 800 may include a column for the new requirements 406, a column for the approach-1 604A, a column for the approach-2 604 B, a column for the approach-3 604C, a column for the rank hierarchy 610, a column for the redundancy score 502, a column for the relevancy score 416, a column for the uniqueness score 802, and a column for an overall score 804 (i.e., the weighted score).

The overall score 804 may be calculated using equation (2).

$$( 2 )$$

$$Overall\_score 802 = ( w 1 * Relevancy score 416 + w 2 * Uniqueness score 602 - w 3 * Redundancy score ) / sum ( weights )$$

By way of an example, the weight ‘w1’ may be ‘1’, the weight ‘w2’ may be ‘0.5’, and the weight ‘w3’ may be ‘3’. In continuation with the above example, some exemplary overall score values for the input requirements corresponding to the cluster requirement ID 402 ‘R1_Cluster1’ are presented in the requirement analysis report 800.

For the new requirement 406 ‘New_Req1’, the approach-1 604A may be ‘R1_High_Level’, the approach-2 604B ‘R1_Medium_Level’, the approach-3 604C may be ‘R1_Low_Level’, the rank 610 may be ‘2.2.5’, the redundancy score 502 may be ‘0.6’, the average relevancy score ‘0.8’, the uniqueness score 602 may be ‘0.76’, and the overall score 804 may be ‘0.58’.

For the input requirement 406 ‘New_Req2’, the approach-1 604A may be ‘R2_High_Level’, the approach-2 604B may be ‘R2_Medium_Level’, the approach-3 604C may be ‘R2_Low_Level’, the rank 610 may be ‘4’, the redundancy score 502 may be ‘0.4, the average relevancy score ‘0.6’, the uniqueness score 602 may be ‘0.19’, and the overall score 804 may be ‘0.41’.

For the new requirement 406 may be ‘New_Req3’, the approach-1 604A may be ‘R3_High_Level’, the approach-2 604B may be ‘R3_Medium_Level’, the approach-3 604C may be ‘R3_Low_Level’, the rank 610 may be ‘1.3.2’, the redundancy score 502 may be ‘0.8’, the average relevancy score ‘0.4’, the uniqueness score 602 may be ‘0.72’, and the overall score 804 may be ‘0.45’.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

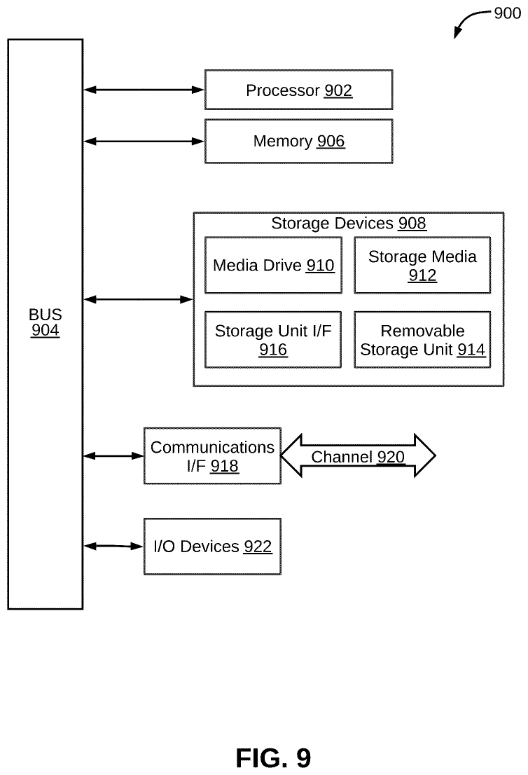

The disclosed methods and systems may be implemented on a conventional or a general-purpose computer system, such as a personal computer (PC) or server computer. Referring now to FIG. 9, an exemplary computing system 900 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 900 may represent, for example, a user device such as a desktop, a laptop, a mobile phone, personal entertainment device, DVR, and so on, or any other type of special or general-purpose computing device as may be desirable or appropriate for a given application or environment. The computing system 900 may include one or more processors, such as a processor 902 that may be implemented using a general or special purpose processing engine such as, for example, a microprocessor, microcontroller, or other control logic. In this example, the processor 902 is connected to a bus 904 or other communication medium. In some embodiments, the processor 902 may be an Artificial Intelligence (AI) processor, which may be implemented as a Tensor Processing Unit (TPU), or a graphical processor unit, or a custom programmable solution Field-Programmable Gate Array (FPGA).

The computing system 900 may also include a memory 906 (main memory), for example, Random Access Memory (RAM) or other dynamic memory, for storing information and instructions to be executed by the processor 902. The memory 906 also may be used for storing temporary variables or other intermediate information during execution of instructions to be executed by the processor 902. The computing system 900 may likewise include a read only memory (“ROM”) or other static storage device coupled to bus 904 for storing static information and instructions for the processor 902.

The computing system 900 may also include storage devices 908, which may include, for example, a media drive 910, a cloud based storage, a network storage, and a removable storage interface. The media drive 910 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 912 may include, for example, a hard disk, magnetic tape, flash drive, or other fixed or removable medium that is read by and written to by the media drive 910. As these examples illustrate, the storage media 912 may include a computer-readable storage medium having stored there in particular computer software or data.

In alternative embodiments, the storage devices 908 may include other similar instrumentalities for allowing computer programs or other instructions or data to be loaded into the computing system 900. Such instrumentalities may include, for example, a removable storage unit 914 and a storage unit interface 916, such as a program cartridge and cartridge interface, a removable memory (for example, a flash memory or other removable memory module) and memory slot, and other removable storage units and interfaces that allow software and data to be transferred from the removable storage unit 914 to the computing system 900.

The computing system 900 may also include a communications interface 918. The communications interface 918 may be used to allow software and data to be transferred between the computing system 900 and external devices. Examples of the communications interface 918 may include a network interface (such as an Ethernet or other NIC card), a communications port (such as for example, a USB port, a micro-USB port), Near field Communication (NFC), etc. Software and data transferred via the communications interface 918 are in the form of signals which may be electronic, electromagnetic, optical, or other signals capable of being received by the communications interface 918. These signals are provided to the communications interface 918 via a channel 920. The channel 920 may carry signals and may be implemented using a wireless medium, wire or cable, fiber optics, or other communications medium. Some examples of the channel 920 may include a phone line, a cellular phone link, an RF link, a Bluetooth link, a network interface, a local or wide area network, and other communications channels.

The computing system 900 may further include Input/Output (I/O) devices 922. Examples may include, but are not limited to a display, keypad, microphone, audio speakers, vibrating motor, LED lights, etc. The I/O devices 922 may receive input from a user and also display an output of the computation performed by the processor 902. In this document, the terms “computer program product” and “computer-readable medium” may be used generally to refer to media such as, for example, the memory 906, the storage devices 908, the removable storage unit 914, or signal(s) on the channel 920. These and other forms of computer-readable media may be involved in providing one or more sequences of one or more instructions to the processor 902 for execution. Such instructions, generally referred to as “computer program code” (which may be grouped in the form of computer programs or other groupings), when executed, enable the computing system 900 to perform features or functions of embodiments of the present invention.

In an embodiment where the elements are implemented using software, the software may be stored in a computer-readable medium and loaded into the computing system 900 using, for example, the removable storage unit 914, the media drive 910 or the communications interface 918. The control logic (in this example, software instructions or computer program code), when executed by the processor 902, causes the processor 902 to perform the functions of the invention as described herein.

Various embodiments provide method and system for determining a priority of implementation for input requirements. The disclosed method and system may add a set of input requirements to a requirement repository. The requirement repository may include a set of existing requirement clusters. Each of the set of existing requirement clusters may include a set of existing requirements. Moreover, for each input requirement of the set of input requirements, the disclosed method and system may determine, via a GenAI model, a weighted average score through a comparison of the input requirement with each of the set of existing requirements in each of the set of existing requirement clusters, based on a set of predefined criteria. The set of predefined criteria may include at least one of relevancy, redundancy, and uniqueness. Thereafter, the disclosed method and system may determine a priority of implementation for each of the set of input requirements based on the weighted average score. The priority for implementation corresponds to an ordered list of the set of input requirements based on the weighted average score.

Thus, the disclosed method and system try to overcome the technical problem of determining a priority of implementation for input requirements. The method and system may determine a priority of implementation for input requirements. The method and system may be used to map an existing requirement to an input requirement efficiently. The method and system may reuse the existing requirements. The method and system may trace the input requirements and a sub-input requirement with the existing requirements efficiently. The method and system may help to optimize a Software Testing Life Cycle (STLC) by helping in generation of an optimal number test cases by prioritizing requirements which are more relevant, more redundant, and more unique.

In light of the above mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system for AI-assisted endoscope navigation. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for determining a priority of implementation for input requirements, the method comprising:
adding, by a computing device, a set of input requirements to a requirement repository, wherein the requirement repository comprises a set of existing requirement clusters, and wherein each of the set of existing requirement clusters comprises a set of existing requirements;
for each input requirement of the set of input requirements, determining, by the computing device via a generative Artificial Intelligence (GenAI) model, a weighted average score through a comparison of the input requirement with each of the set of existing requirements in each of the set of existing requirement clusters, based on a set of predefined criteria, wherein the set of predefined criteria comprises at least one of relevancy, redundancy, and uniqueness; and
determining, by the computing device, a priority of implementation for each of the set of input requirements based on the weighted average score, wherein the priority for implementation corresponds to an ordered list of each of the set of input requirements based on the weighted average score.

2. The method as claimed in claim 1, comprising:
preprocessing, by the computing device, a plurality of existing requirements using a set of preprocessing techniques; and
clustering, by the computing device, each of the plurality of existing requirements into the set of existing requirement clusters based on predefined criteria using one of a clustering algorithm or the GenAI model.

3. The method as claimed in claim 1, wherein comparison of the input requirement based on a predefined criteria of relevancy comprises computing, via the GenAI model, a relevancy score of the input requirement based on a relevancy comparison of the input requirement with each of the set of existing requirement clusters, wherein computing the relevancy score comprises:
for each of the set of existing requirement clusters,
generating, by the computing device via the GenAI model, a question based on each existing requirement of the set of existing requirements to obtain a set of questions;
for each of the set of input requirements, generating, by the computing device via the GenAI model, an answer based on the input requirement corresponding to each of the set of questions, to obtain a set of answers; and
for each of the set of input requirements, computing, by the computing device via the GenAI model, the relevancy score corresponding to the input requirement based on a comparison between each of the set of answers with the corresponding set of questions.

4. The method as claimed in claim 1, wherein comparison of the input requirement based on a predefined criteria of redundancy comprises calculating, via the GenAI model, the redundancy score of the input requirement based on a metadata overlap analysis between the input requirement and each of the set of existing requirement clusters, wherein calculating the redundancy score comprises:
for each of the set of existing requirement clusters,
for each of the set of input requirements, comparing, by the computing device via the GenAI model, metadata of the input requirement with each existing requirement of the set of existing requirements, wherein the metadata comprise description content associated with the input requirement; and
for each of the set of input requirements, calculating, by the computing device via the GenAI model, the redundancy score of the input requirement based on the comparison.

5. The method as claimed in claim 1, wherein comparison of the input requirement based on a predefined criteria of uniqueness comprises calculating, via the GenAI model, the uniqueness score of the input requirement based on an iterative comparison amongst the one or more new requirements, wherein calculating the uniqueness score of the input requirement comprises:
for each of the set of input requirements, generating, by the computing device via the GenAI model, a set of level classifications corresponding to the input requirement, wherein the set of level classifications comprises a high level classification, a medium level classification, and a low level classification;
randomly creating, by the computing device via the GenAI model, one or more batches from the set of input requirements, wherein each of the one or more batches comprises a first predefined number of input requirements;
for each of one or more iterations,
for each of the one or more batches, assigning, by the computing device via the GenAI model, a hierarchy rank to each of the first predefined number of input requirements in the batch based on a similarity analysis;
for each of the one or more batches, selecting, by the computing device, a second predefined number of input requirements from the first predefined number of input requirements based on the rank; and
forming, by the computing device, new hierarchy batches from the second predefined number of input requirements for a next iteration of the one or more iterations, wherein each of the new hierarchy batches comprises the first predefined number of the selected input requirements; and
for each of the set of input requirements, calculating, by the computing device, the uniqueness score of the input requirement based on associated hierarchy ranks at the one or more iterations.

6. The method as claimed in claim 1, comprising generating, by the computing device, a requirement analysis report based on the priority of implementation for each of the set of input requirements.

7. A system for determining a priority of implementation for input requirements, the system comprising:
a processor; and
a memory communicatively coupled to the processor, wherein the memory stores processor executable instructions, which, on execution, causes the processor to:
add a set of input requirements to a requirement repository, wherein the requirement repository comprises a set of existing requirement clusters, and wherein each of the set of existing requirement clusters comprises a set of existing requirements;
for each input requirement of the set of input requirements, determine, via a GenAI model, a weighted average score through a comparison of the input requirement with each of the set of existing requirements in each of the set of existing requirement clusters, based on a set of predefined criteria, wherein the set of predefined criteria comprises at least one of relevancy, redundancy, and uniqueness; and
determine a priority of implementation for each of the set of input requirements based on the weighted average score, wherein the priority for implementation corresponds to an ordered list of each of the set of input requirements based on the weighted average score.

8. The system as claimed in claim 7, wherein for comparison of the input requirement based on a predefined criteria of relevancy, the processor executable instructions further cause the processor to compute, via the GenAI model, a relevancy score of the input requirement based on a relevancy comparison of the input requirement with each of the set of existing requirement clusters, wherein computing the relevancy score comprises:
for each of the set of existing requirement clusters,
generate, via the GenAI model, a question based on each existing requirement of the set of existing requirements to obtain a set of questions;
for each of the set of input requirements, generate, via the GenAI model, an answer based on the input requirement corresponding to each of the set of questions, to obtain a set of answers; and
for each of the set of input requirements, compute, via the GenAI model, the relevancy score corresponding to the input requirement based on a comparison between each of the set of answers with the corresponding set of questions.

9. The system as claimed in claim 7, wherein for comparison of the input requirement based on a predefined criteria of redundancy, the processor executable instructions further cause the processor to calculate, via the GenAI model, the redundancy score of the input requirement based on a metadata overlap analysis between the input requirement and each of the set of existing requirement clusters, wherein calculating the redundancy score comprises:
for each of the set of existing requirement clusters,
for each of the set of input requirements, compare, via the GenAI model, metadata of the input requirement with each existing requirement of the set of existing requirements, wherein the metadata comprise description content associated with the input requirement; and
for each of the set of input requirements, calculate, via the GenAI model, the redundancy score of the input requirement based on the comparison.

10. The system as claimed in claim 7, wherein for comparison of the input requirement based on a predefined criteria of uniqueness, the processor executable instructions further cause the processor to calculate, via the GenAI model, the uniqueness score of the input requirement based on an iterative comparison amongst the one or more new requirements, wherein calculating the uniqueness score of the input requirement comprises:
for each of the set of input requirements, generate, via the GenAI model, a set of level classifications corresponding to the input requirement, wherein the set of level classifications comprises a high level classification, a medium level classification, and a low level classification;
randomly create, via the GenAI model, one or more batches from the set of input requirements, wherein each of the one or more batches comprises a first predefined number of input requirements;
for each of one or more iterations,
for each of the one or more batches, assign, via the GenAI model, a hierarchy rank to each of the first predefined number of input requirements in the batch based on a similarity analysis;
for each of the one or more batches, select a second predefined number of input requirements from the first predefined number of input requirements based on the rank; and
form new hierarchy batches from the second predefined number of input requirements for a next iteration of the one or more iterations, wherein each of the new hierarchy batches comprises the first predefined number of the selected input requirements; and
for each of the set of input requirements, calculate the uniqueness score of the input requirement based on associated hierarchy ranks at the one or more iterations.
